(19) United States
(12) Patent Application Publication
(10) Pub. No.: US 2015/0163068 A1
(43) Pub. Date: Jun. 11, 2015

(54) CONTROL OF COMPUTING DEVICE USE DURING CONFERENCES

(71) Applicant: Lenovo Enterprise Solutions (Singapore) PTE. LTD., Singapore (SG)

(72) Inventors: Gary D. Cudak, Creedmoor, NC (US); Christopher J. Hardee, Raleigh, NC (US); Adrian X. Rodriguez, Durham, NC (US)

(21) Appl. No.: 14/101,475

(22) Filed: Dec. 10, 2013

Related U.S. Application Data
(63) Continuation of application No. 14/100,056, filed on Dec. 9, 2013.

(51) Int. Cl. H04L 12/18; H04L 29/08

(52) U.S. Cl. CPC H04L 12/1822; H04L 67/22

(57) ABSTRACT

Systems and methods for control of computing device use during conferences are disclosed. According to an aspect, a method includes receiving a communication that defines a rule for controlling use of a computing device during a conference associated with the computing device. The method also includes determining occurrence of the conference. Further, the method includes applying the rule to control use of the computing device during occurrence of the conference in response to determining occurrence of the conference.

### CROSS-REFERENCE TO RELATED APPLICATIONS

This is a continuation application of copending U.S. patent application Ser. No. 14/100,056, filed Dec. 9, 2013 and titled CONTROL OF COMPUTING DEVICE USE DURING CONFERENCES, the content of which is hereby incorporated by reference in its entirety.

### BACKGROUND

1. Field of the Invention

The present invention relates to access control software, and more specifically, to control of computing device use during conferences.

2. Description of Related Art

Often, during meetings or conferences, some attendees begin to become disinterested and seek distraction in various applications or web destinations on their computing devices. For example, attendees may access a social network application during a conference, or attempt to play a video game on their computing device. As a result, the attendee may miss important conversation or other elements of the presentation while accessing the social network or playing a video game during the conference. For this reason, meeting efficiency and productivity can be reduced and continuity of conversation interrupted during the conference. For at least this reason, there is a need for systems and techniques for reducing distractions during a conference to enhance efficiency and productivity.

### BRIEF SUMMARY

Systems and method for control of computing device use during conferences are disclosed herein. According to an aspect, a method may include receiving a communication that defines a rule for controlling use of a computing device during a conference associated with the computing device. The method may also include determining occurrence of the conference. The method may also include—applying the rule to control use of the computing device during occurrence of the conference in response to determining occurrence of the conference.

According to another aspect, the method may include receiving specification for controlling use of a computing device during a conference associated with the computing device. The method may also include generating a rule based on the specification. Further, the method may also include, communicating to the computing device the rule for application in controlling use of the computing device during the conference.

### BRIEF DESCRIPTION OF THE SEVERAL VIEWS OF THE DRAWINGS

FIG. 1 is a block diagram of a system for controlling a computing device during occurrence of a conference in accordance with embodiments of the present invention;

FIG. 2 is a flowchart of an example method for controlling use of a computing device during a conference associated with the computing device in accordance with embodiments of the present invention;

FIG. 3 is a flowchart of an example method for receiving user input for one of accepting, rejecting, and changing a rule in accordance with embodiments of the present invention;

FIG. 4 is a screen display of an example user interface for displaying, on a user interface of a computing device, a specification of a rule in accordance with embodiments of the present invention;

FIG. 5 is a screen display of an example user interface for receiving a user input for requesting a change to the rule in accordance with embodiments of the present invention;

FIG. 6 is a flowchart of an example method for receiving a user input requesting access to a restricted activity specified in the rule, the rule specifying a deviation allowance for allowing access to the restricted activity within a predetermined use limit in accordance with embodiments of the present invention;

FIG. 7 is a flowchart of an example method for receiving input of a specification for controlling use of a computing device during a conference associated with the computing device in accordance with embodiments of the present invention;

FIG. 8 is a flowchart of an example method for presenting a user interface configured to receive input of the specification in accordance with embodiments of the present invention;

FIG. 9 is a flowchart of an example method for determining access activity of a user interface associated with a presenter for the conference and updating the rule based on the access activity of the user interface in accordance with embodiments of the present invention;

FIG. 10 is a flowchart of an example method for receiving input of a specification for a deviation allowance for enabling access to a restricted activity of the rule in accordance with embodiments of the present invention; and

FIG. 11 is an example user interface for receiving input of a specification for controlling use of a computing device during a conference associated with the computing device in accordance with embodiments of the present invention in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, one of multiple computing devices communicatively connected via one or more networks. In another example, a computing device may be a mobile computing device such as, for example, but not limited to, a smart phone, a cell phone, a pager, a personal digital assistant (PDA), a mobile computer with a smart phone client, or the like. A computing device can also include any type of conventional computer, for example, a laptop computer or a tablet computer. Typically, these computing devices use graphical displays and can access the Internet (or other communications network) on a web browser.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

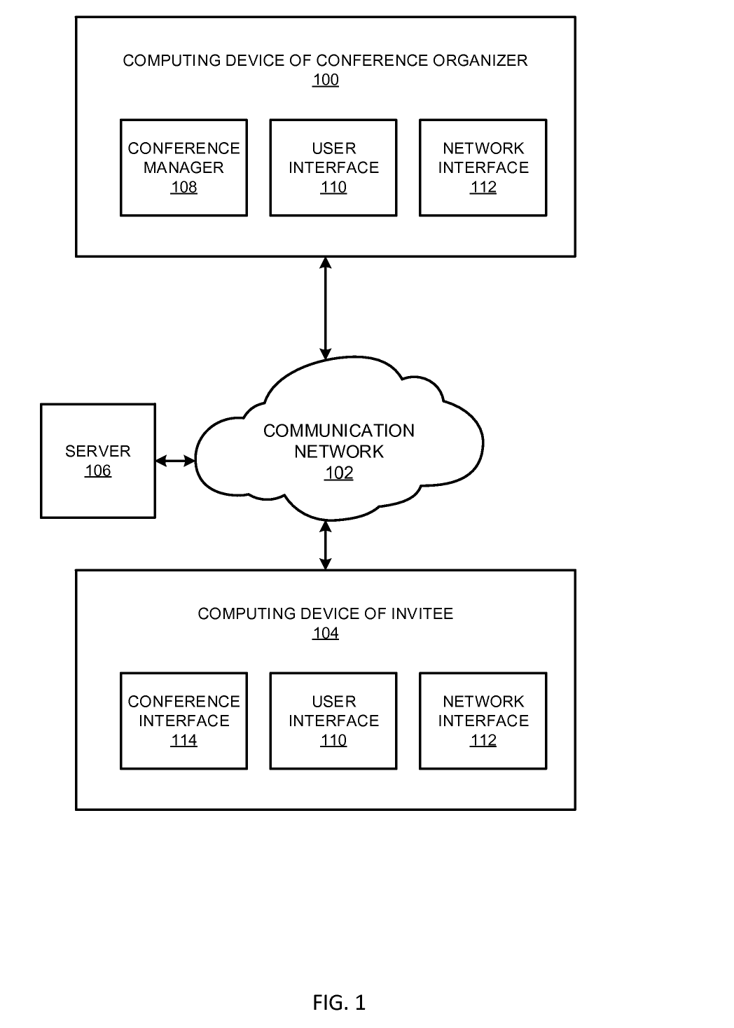

The presently disclosed invention is now described in more detail. For example, FIG. 1 illustrates a block diagram of a system for controlling a computing device 100 during occurrence of a conference in accordance with embodiments of the present invention. Referring to FIG. 1, the computing device 100 may be communicatively connected to another computing device 104 via communication network 102. The communication network 102 may be, for example, but not limited to, the Internet, a wide area network (WAN), a wireless network, a local area network (LAN), the like, or combinations thereof. Although FIG. 1 demonstrates two computing devices communicating over communication network 102 during occurrence of a conference, it should be understood that other computing devices may be communicatively connected to communication network 102 during occurrence of a conference.

As referred to herein, the term “conference” may refer to an organized interaction among two or more people. For example, a conference may be a meeting between two or more people within the same environment, such as a conference room. In another example, a conference may be a conference call among two or more people. In another example, a conference may be any type of computer-enabled interaction among two or more people such as, but not limited to, an on-demand collaboration, online meeting, web conference, or videoconference. As an example, a web conference can be any type of computer-enabled user interaction that allows conference events to be shared with remote locations. Conference events that may be shared among participants or attendees to the conference may include, but are not limited to, video, images, voice communications, presentation, or the like. A videoconference may be implemented by any suitable telecommunication system configured to provide simultaneous two-way video and audio transmissions among two or more locations.

The computing device 100 can be operated by an organizer of a conference involving the computing device 100 and the computing device 104, which can be operated by an invitee of the conference. Although only one invitee computing device is depicted in this example, any number of computing devices may be invited to join in the conference. In this example, the conference is a web conference implemented by a web server 106. The web server 106 may be communicatively connected to the computing device 100 and computing device 104 via the communication network 102. Further, the web server 106 may be configured to manage a conference between the computing devices 100 and 104.

The computing device 100 can include a conference manager 108, a user interface 110, and a network interface 112. The user interface 110 may include, but is not limited to, a keyboard, a mouse, a display, and the like. The conference manager 108 may be configured to implement functionality described in further detail herein in accordance with embodiments of the present invention. For example, the conference manager 108 may be configured to receive specification for controlling use of the computing device 104 during a conference implemented by the server 106 and associated with the computing device 104. The specification may indicate, for example, an allowable activity and/or a restricted activity on the computing device 104. Further, for example, the conference manager 108 may generate a rule based on the specification. The conference manager 108 may control the network interface 110 to communicate to the computing device 104 the rule for application in controlling use of the computing device 104 during the conference. The conference manager 108 may be implemented by hardware, software, firmware, or combinations thereof. As an example, the conference manager 108 may be implemented by one or more processors and memory.

The computing device 104 may include a conference interface 108, a user interface 110, and a network interface 112. The conference interface 108 may be configured to implement functionality described in further detail herein in accordance with embodiments of the present invention. For example, the conference manager 108 may be configured to receive the communication from the computing device 100 that defines a rule for controlling use of the computing device 104 during the conference. The server 106 may implement, for example, a web conference between the computing devices 100 and 104. The conference interface 114 may determine occurrence of the conference. Further, the conference interface 114 may apply the rule to control use of the computing device 104 during occurrence of the conference in response to determining occurrence of the conference. The conference interface 108 may be implemented by hardware, software, firmware, or combinations thereof. As an example, the conference interface 108 may be implemented by one or more processors and memory.

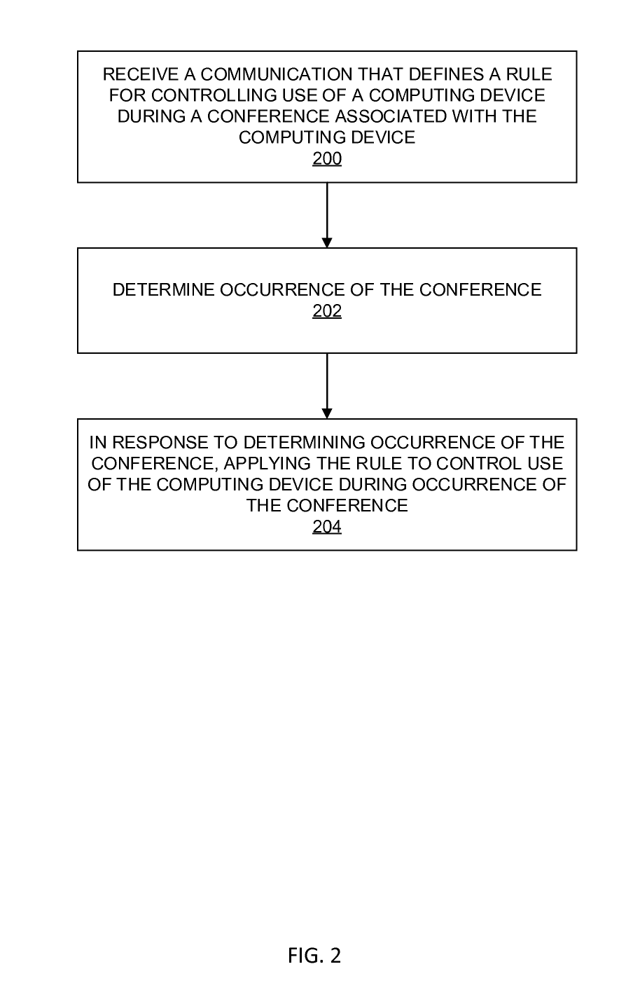

In accordance with embodiments of the present invention, FIG. 2 is a flowchart of an example method for controlling use of a computing device during a conference associated with the computing device. In this example, the method is described as being implemented by computing device 104 shown in FIG. 1, although it should be understood that the method may be suitably implemented in any suitable computing device or environment. Referring to FIG. 2, the method includes receiving 200 a communication that defines a rule for controlling use of a computing device during a conference associated with the computing device. For example, the computing device 100 may generate a communication that defines a rule for controlling use of the computing device 104 during a conference associated with the computing device 104. Further, the computing device 100 may communicate the rule to the computing device 104 via the communication network 102. The computing device 104 may receive the communication. The computing device 100 may be a computing device operated by the presenter for the conference. The computing device 104 may be a computing device of an attendee of the conference.

In accordance with embodiments of the present invention, a rule for controlling use of a computing device may specify one or both of an allowable activity and a restricted activity on the computing device. For example, the allowable activity or restricted activity may define utilization of a web browser for browsing one or more websites available to computing device 100. In a further example, the allowable activity or restricted activity may be an operation within an application available to computing device 100. It should be understood that an application available to computing device 100 may comprise a spreadsheet application, presentation application, calendar application, multimedia applications, electronic mail applications, gaming applications, and the like. Such applications may be controlled by implementation of the rule. The conference interface 114 may control application of the rule for controlling an application residing on the computing device 104.

The method of FIG. 2 includes determining 202 occurrence of the conference. Continuing the aforementioned example, the conference interface 114 may determine occurrence of the conference based on a calendar application available to computing device 100. For example, the conference may be scheduled for a particular day and time, and the conference interface 114 may determine that the conference is occurring based on the calendar. In another example, computing device 100 may determine the occurrence of the conference based on a location-based application available to computing device 100. In another example, computing device 100 may determine the occurrence of the conference based on a conference application available to computing device 100.

The method of FIG. 2 includes applying 204 the rule to control use of the computing device during occurrence of the conference in response to determining occurrence of the conference. Continuing the aforementioned example, the rule may specify only spreadsheet applications may be accessed during occurrence of the conference. In response to determining occurrence of the conference, the conference interface 114 may permit access to spreadsheet applications available to computing device 100, but may restrict access to some or all other applications or websites available to computing device 100. In another example, the rule may specify access to social network applications or websites are restricted during occurrence of the conference. In this case, in response to determining occurrence of the conference, the conference interface 114 may restrict access to social network applications and websites available to computing device 100. In this way, the computing device 104 may be controlled during the conference. One or more other computing devices may similarly be controlled.

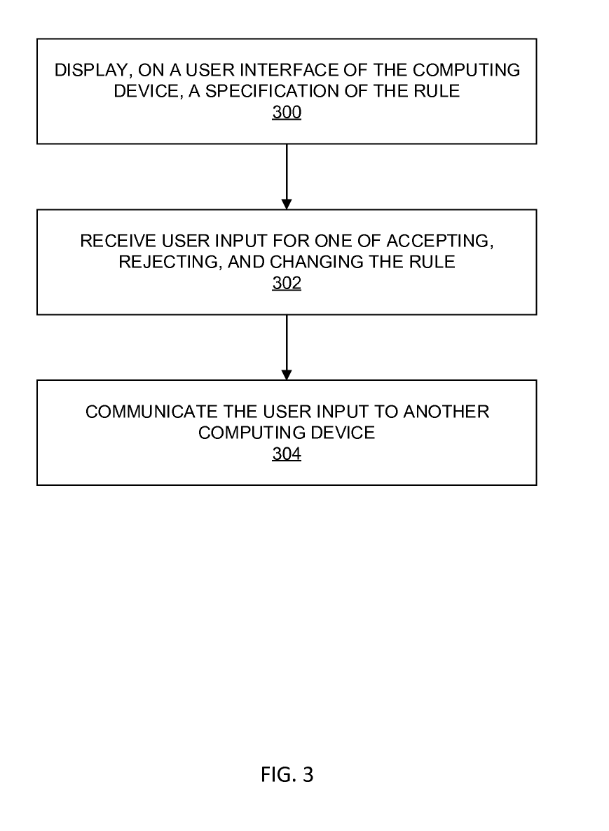

FIG. 3 is a flowchart of an example method for receiving user input for one of accepting, rejecting, and changing the rule in accordance with embodiments of the present invention. In this example, the method is described as being implemented by computing device 104 shown in FIG. 1, although it should be understood that the method may be suitably implemented in any suitable computing device or environment. Referring to FIG. 3, the method may include displaying 300, on a user interface of the computing device, a specification of the rule. For example, a specification of a rule may be displayed on a display of the user interface 110. The conference manager 108 may control the display to display specification of the rule.

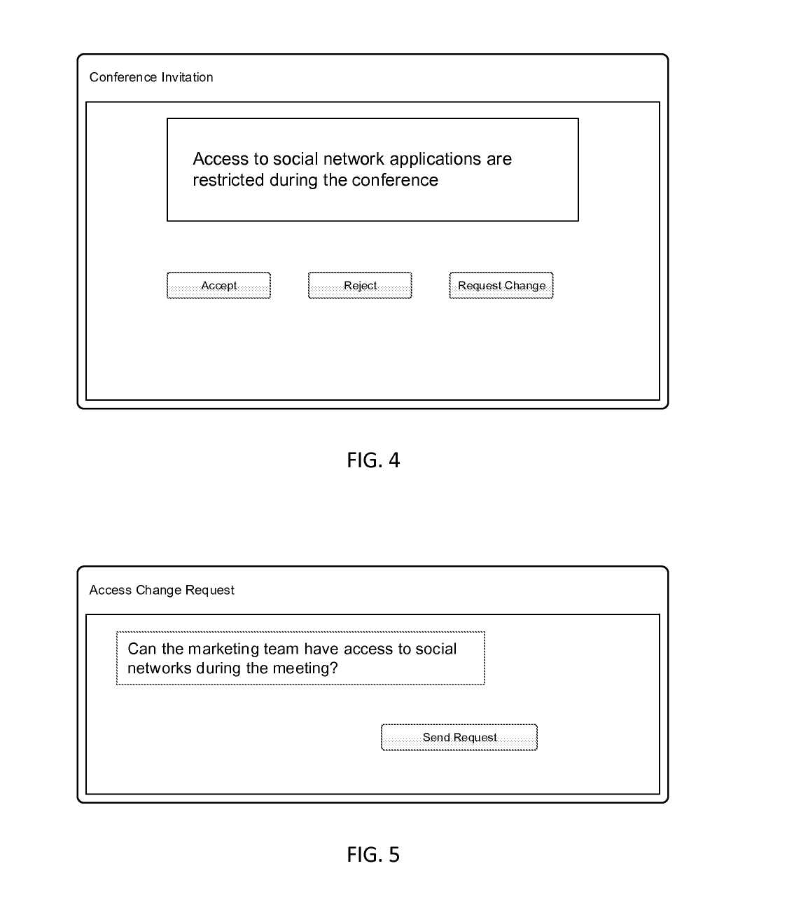

As an example, FIG. 4 depicts a screen display of an example user interface for displaying a specification of the rule in accordance with embodiments of the present invention. For example, the user interface of FIG. 4 shows a conference invitation and a specification of the rule for controlling use of computing device 104 during occurrence of the conference. In this example, access to social networking applications may be restricted during the conference.

The method of FIG. 3 includes receiving 302 user input for one of accepting, rejecting, and changing the rule. Continuing the aforementioned example, FIG. 4 shows buttons that may be selected for accepting, rejecting, or requesting a change to the rule. In an example, the computing device 100 may receive a user input requesting a change to the rule. FIG. 5 is a screen display of an example user interface for receiving a user input for requesting a change to the rule in accordance with embodiments of the present invention. As shown in FIG. 5, the computing device 100 provides the user interface 104 configured to receive a request from a member of the marketing team participating in the conference to have access to social networks during the conference.

The method of FIG. 3 includes communicating 304 the user input to another computing device. For example, the computing device 100 may then send the request to computing device 104. In response to receipt of the request, the computing device 104 may implement the request.

In accordance with embodiments of the present invention, the computing device 104 may receive an update to the rule for controlling use of a computing device 104 during the conference. For example, the computing device 104 may receive the update to the rule from computing device 100 in response to the request to change the rule as discussed with respect to FIG. 5. The update may specify that the marketing team may use their computing devices to access social networks during the conference. The conference interface 114 may receive the rule change and permit access to social networks in response to receipt of the rule change. However, it should be understood that the computing device 100 may receive an update to the rule at any time prior or during occurrence of the conference. For example, computing device 104 may receive an update to the rule from computing device 100 such that the update requires access to electronic mail applications to also be restricted during the conference. In both examples, computing device 100 may apply the update to the rule during occurrence of the conference.

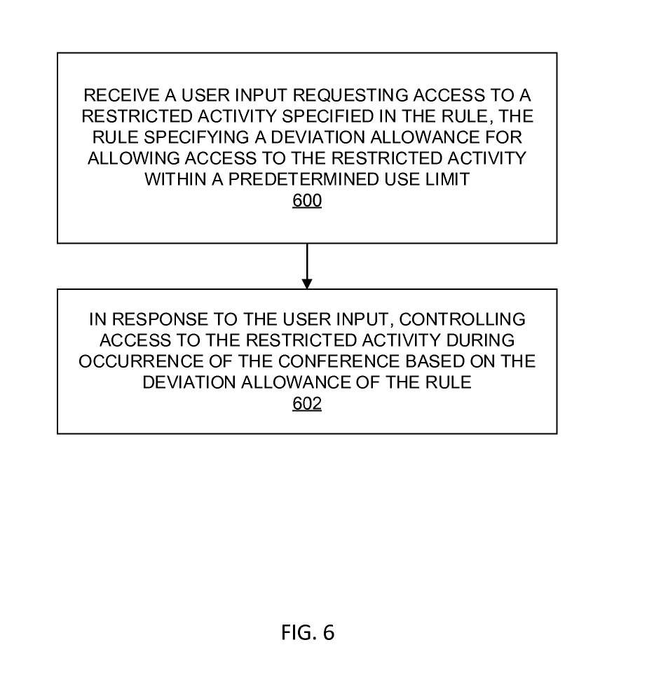

FIG. 6 is a flowchart of an example method for receiving a user input requesting access to a restricted activity specified in the rule, the rule specifying a deviation allowance for allowing access to the restricted activity within a predetermined use limit in accordance with embodiments of the present invention. In this example, the method is described as being implemented by computing device 104 shown in FIG. 1, although it should be understood that the method may be suitably implemented in any suitable computing device or environment. Referring to FIG. 6, the method includes receiving 600 a user input requesting access to a restricted activity specified in the rule, the rule specifying a deviation allowance for allowing access to the restricted activity within a predetermined use limit. For example, a user of the computing device 104 may input a request into the user interface 110 to access a restricted activity, such as, but not limited to, a social network website, during occurrence of the conference. The conference interface 114 may receive the user input. In this example, the rule may comprise a deviation allowance enabling computing device 104 to access the social network website during occurrence of the conference for a predetermined use limit. The predetermined use limit of the deviation allowance may specify a predetermined number of times computing device 100 is permitted to access the restricted activity during occurrence of the conference. For example, the deviation allowance may specify computing device 104 is limited to accessing the social networking website twice during occurrence of the conference. In another example, the predetermined use limit of the deviation allowance may specify a predetermined period of time computing device 104 is permitted to access the restricted activity during occurrence of the conference. In another example, the deviation allowance may specify that the social networking website may be accessed for two minutes or another specified time period during occurrence of the conference.

The method of FIG. 6 includes controlling 602 access to the restricted activity during occurrence of the conference based on the deviation allowance of the rule, in response to the user input. Continuing the aforementioned example, the conference interface 114 of the computing device 104 may enable access to the social network website for two minutes during occurrence of the conference.

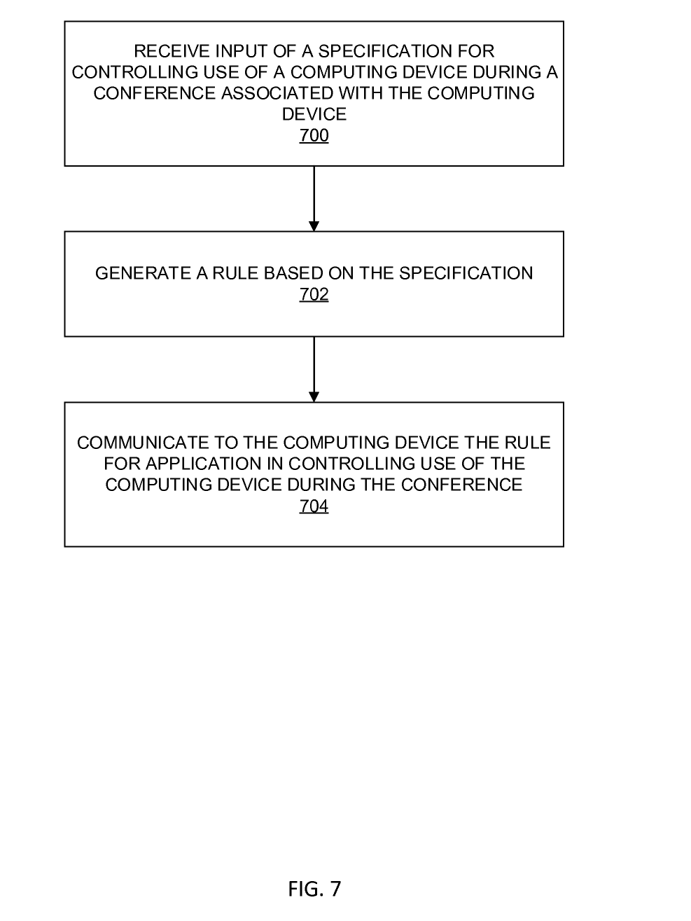

FIG. 7 is a flowchart of an example method for receiving input of a specification for controlling use of a computing device during a conference associated with the computing device in accordance with embodiments of the present invention. In this example, the method is described as being implemented by computing device 100 shown in FIG. 1, although it should be understood that the method may be suitably implemented in any suitable computing device or environment. Referring to FIG. 7, the method includes receiving 700 input of a specification for controlling use of a computing device during a conference associated with the computing device. For example, the conference manager 108 of the computing device 100 may receive a specification for controlling use of computing device 100 during a conference associated with computing device 100. The specification for controlling use of computing device 100 may specify one of an allowable activity and a restricted activity on computing device 100. As an example, a user may interact with the user interface 110 to input the specification.

The method of FIG. 7 includes generating 702 a rule based on the specification. Continuing in the aforementioned example, computing device 100 may generate a rule based on the specification as demonstrated in examples provided herein. The method includes communicating 704 to the computing device the rule for application in controlling use of the computing device during the conference. For example, the computing device 100 may communicate to the computing device 104 the rule for application in controlling use of the computing device 104 during the conference. In response to receipt of the rule, the computing device 104 may implement the rule.

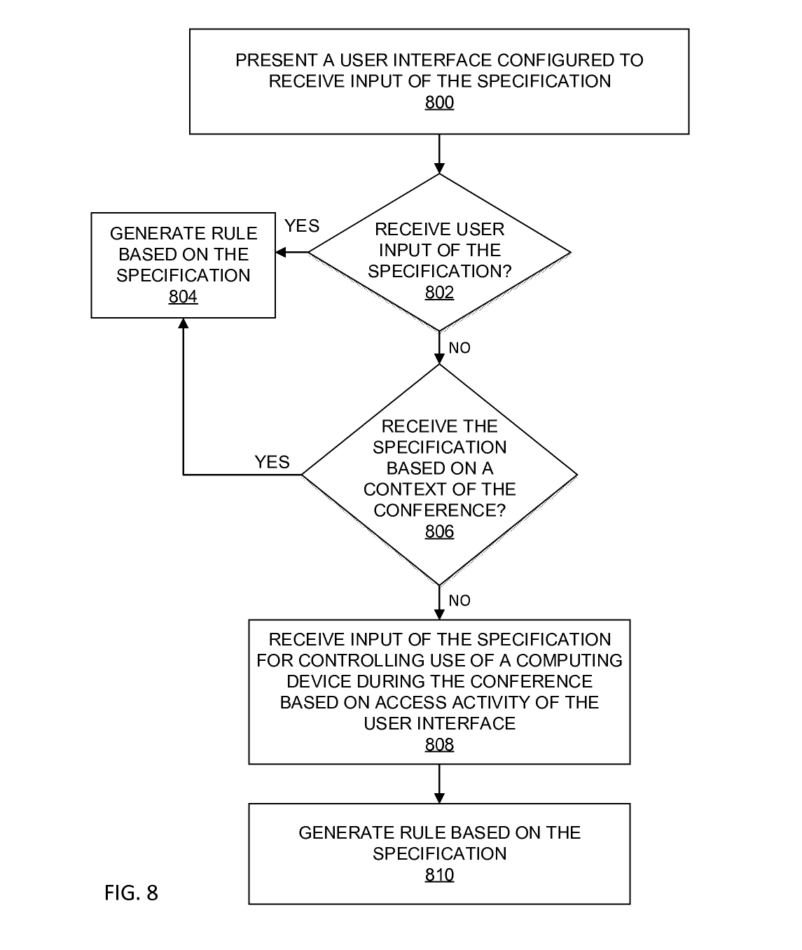

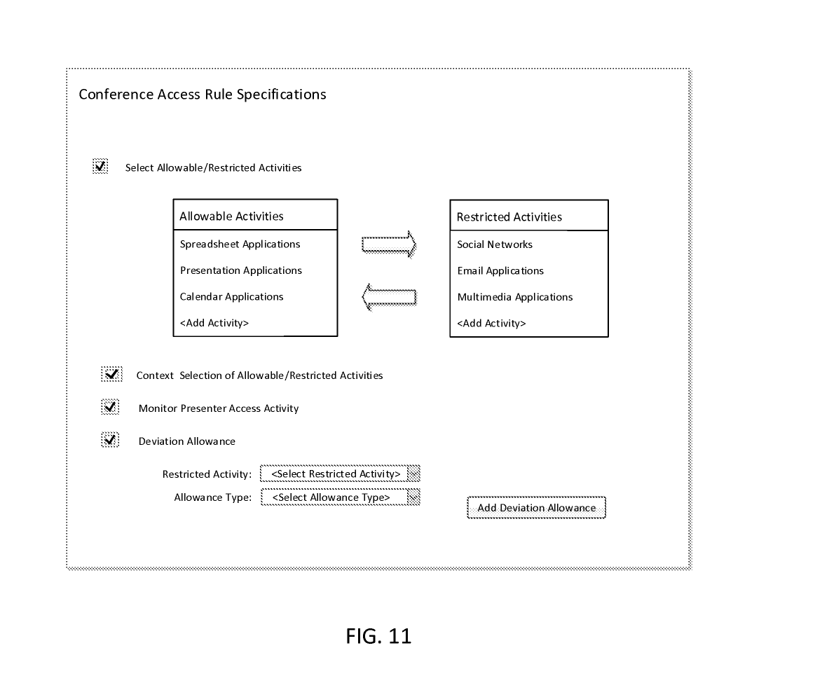

FIG. 8 is a flowchart of an example method for presenting a user interface configured to receive input of the specification in accordance with embodiments of the present invention. In this example, the method is described as being implemented by computing device 100 shown in FIG. 1, although it should be understood that the method may be suitably implemented in any suitable computing device or environment. Referring to FIG. 8, the method includes presenting 800 a user interface configured to receive input of the specification. For example, the conference manager 108 may receive user input of the specification from the user interface 110. As an example, FIG. 11 depicts a screen display of a user interface for receiving input of a specification for controlling use of a computing device during a conference associated with the computing device in accordance with embodiments of the present invention in accordance with embodiments of the present invention.

Referring to FIG. 11, the display may be suitably interacted with to receive input of a specification for controlling use of computing device 100 during a conference associated with computing device 100. Referring to FIG. 8, the method also includes receiving 802 user input of the specification. As shown in the example of FIG. 11, the user interface 110 of the computing device 100 can enable a user of computing device 104 to input a selection of allowable and/or restricted activities during occurrence of the conference. The user interface shown in FIG. 11 demonstrates the user may select from a list of allowable activities and/or restricted activities. The user interface of FIG. 11 shows that a user may select arrow buttons in order to move an activity from the allowable list to the restricted list and vice versa. The user interface of FIG. 11 also shows inputs for a user to interact with for adding an additional activity to the allowable and/or restricted activity list if the desired activity to control is not listed.

Referring to FIG. 8, the method also demonstrates generating 804 the rule based on receiving 802 user input of the specification. However, the method also demonstrates receiving may comprise receiving 806 the specification based on the context of the conference. As shown in FIG. 11, the user interface presented on computing device 104 enables a user of computing device 104 to request computing device 104 to auto select allowable and/or restricted activities based on the context of the conference. The method of FIG. 8 includes generating 806 the rule based on receiving 806 the specification based on the context of the conference.

In accordance with embodiments of the present invention, a context of the conference may comprise a topic associated with the conference. For example, the topic of the conference may be the quarterly budget for a department of a company. Based on this topic, computing device 104 may determine an allowable activity, such as, but not limited to, spreadsheet applications.

In accordance with embodiments of the present invention, a context of the conference may specify information associated with a participant of the conference. For example, a participant of the conference utilizing computing device 104 may be a member of a finance department. Based on this information, the conference manager 108 of the computing device 100 may determine an allowable activity such as, but not limited to, spreadsheet applications, but may restrict all other activities available to the participant on computing device 100. In another example, a participant of the conference utilizing computing device 100 may be a member of a marketing department. Based on this information, the conference manager 108 of the computing device 100 may determine an allowable activity, such as, but not limited to, social networking applications.

In accordance with embodiments of the present invention, the context of the conference may comprise information associated with a presenter of the conference. For example, a presenter of the conference may be the president of a company. Based on this information, the conference manager 108 of the computing device 100 may determine an allowable activity, such as, but not limited to, presentation applications, but may restrict all other activities available to a participant of the conference utilizing computing device 100. In another example, a presenter of the conference may be a marketing director. Based on this information, the conference manager 108 of the computing device 100 may determine an allowable activity, such as, but not limited to, social networking applications.

Referring to FIG. 8, the method includes receiving 808 input of the specification for controlling use of a computing device during the conference based on the access activity of the user interface. As shown in the example of FIG. 11, the user interface of the computing device 100 can enable a user of computing device 104 to request computing device 104 to dynamically select allowable and/or restricted activities based on a presenter's access activity. The method of FIG. 8 includes generating 810 the rule based on receipt of the input of the specification for controlling use of a computing device during the conference based on the access activity of the user interface.

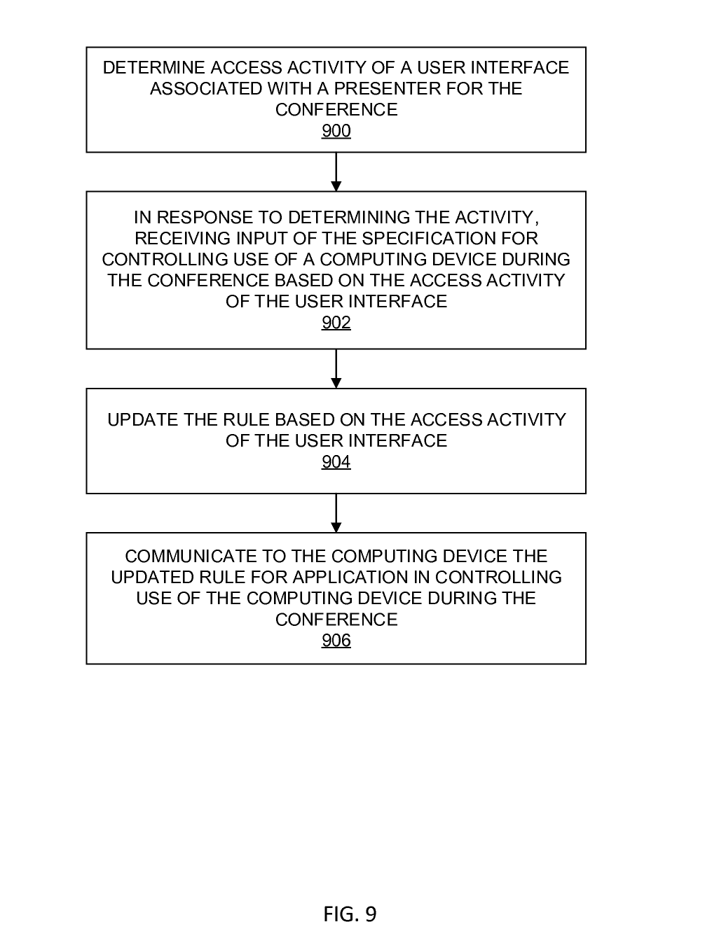

FIG. 9 is a flowchart of an example method for determining access activity of a user interface associated with a presenter for the conference and updating the rule based on the access activity of the user interface in accordance with embodiments of the present invention. In this example, the method is described as being implemented by computing device 100 shown in FIG. 1, although it should be understood that the method may be suitably implemented in any suitable computing device or environment. Referring to FIG. 9, the method includes determining 900 access activity of a user interface associated with a presenter for the conference. For example, a presenter for the conference may utilize computing device 104 during occurrence of the conference. In this example, the conference manager 108 of the computing device 100 may monitor the user interface 110 of computing device 100 to determine the access activity of the presenter during the conference.

The method of FIG. 9 includes receiving 902 input of the specification for controlling use of a computing device during the conference based on the access activity of the user interface in response to determining the activity. For example, the conference manager 108 of the computing device 100 may determine the presenter utilizing the user interface of computing device 104 is accessing a social networking application. In response, the conference manager 108 of the computing device 100 may determine an allowable activity to be accessing social networking applications.

The method of FIG. 9 includes updating 904 the rule based on the access activity of the user interface. Continuing the aforementioned example, the conference manager 108 of the computing device 100 may update the rule such that an allowable activity comprises social networking applications.

The method of FIG. 9 includes communicating 906 to the computing device the updated rule for application in controlling use of the computing device during the conference. Continuing the aforementioned example, the conference manager 108 of the computing device 100 may communicate the updated rule to computing device 104 so that computing device 104 may access social network applications while the presenter for the conference is accessing social network applications during the conference. The method of FIG. 9 may be repeated each time the presenter of the conference accesses a new or different activity.

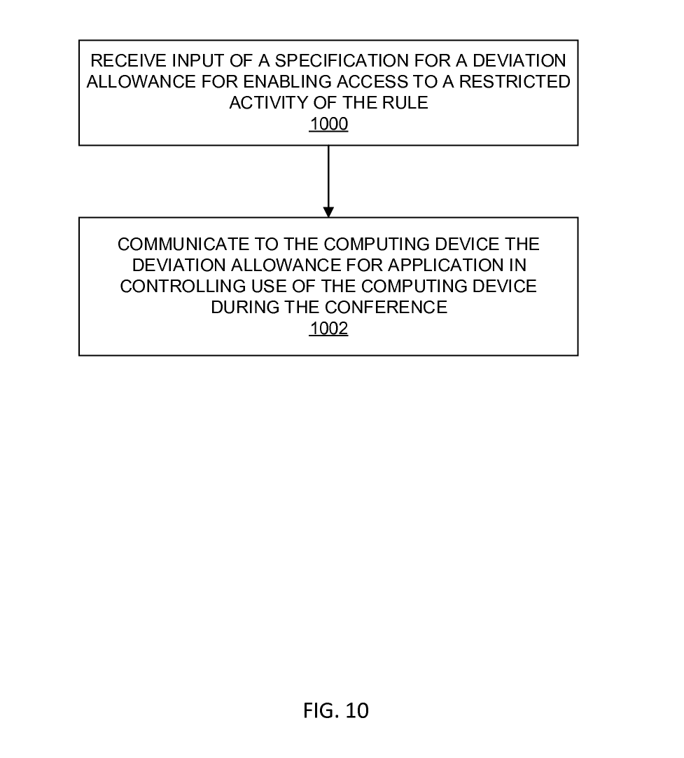

FIG. 10 is a flowchart of an example method for receiving input of a specification for a deviation allowance for enabling access to a restricted activity of the rule in accordance with embodiments of the present invention. In this example, the method is described as being implemented by computing device 100 shown in FIG. 1, although it should be understood that the method may be suitably implemented in any suitable computing device or environment. Referring to FIG. 10, the method includes receiving 1000 input of a specification for a deviation allowance for enabling access to a restricted activity of the rule. As shown in the example of FIG. 11, the user interface presented on computing device 100 can receive a user input indicating a deviation allowance for a restricted activity specified in the rule. For example, the user interface may present a pull-down list enabling a user of computing device 100 to select a restricted activity, such as multimedia application. FIG. 11 also shows that the user interface may present another pull-down list enabling a user of computing device 100 to select a predetermined use limit for the selected restricted activity. Continuing the aforementioned example, a user of computing device 100 may interact with the user interface to control the computing device 100 to access multimedia applications for two minutes during occurrence of the meeting. FIG. 11 further shows the user interface provides an “Add Deviation Allowance” button to enable a user of computing device 100 to add the deviation allowance to the rule.

FIG. 11 is an example user interface for receiving input of a specification for controlling use of a computing device during a conference associated with the computing device in accordance with embodiments of the present invention, as discussed above. It should be understood that the user interface for receiving input of a specification may vary according to application and should not be limited by the example provided in FIG. 11.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at a computing device:
receiving a communication that defines a rule for controlling use of the computing device during a conference associated with the computing device;
determining occurrence of the conference; and
in response to determining occurrence of the conference, applying the rule to control use of the computing device during occurrence of the conference.

2. The method of claim 1, wherein the rule specifies one of an allowable activity and a restricted activity on the computing device.

3. The method of claim 2, wherein the one of the allowable activity and the restricted activity comprises utilization of a web browser for browsing one or more websites.

4. The method of claim 2, wherein the one of the allowable activity and the restricted activity comprises an operation within an application residing on the computing device.

5. The method of claim 1, further comprising displaying, on a user interface of the computing device, a specification of the rule.

6. The method of claim 1, further comprising receiving user input for one of accepting, rejecting, and changing the rule.

7. The method of claim 1, further comprising:
receiving a request to change the rule; and
communicating the request to another computing device.

8. The method of claim 1, further comprising receiving an update to the rule, and
wherein applying the rule comprises applying the update to the rule.

9. The method of claim 1, wherein the rule specifies a deviation allowance for allowing access to a restricted activity within a predetermined use limit.

10. The method of claim 9, wherein the deviation allowance specifies a predetermined number of times the computing device is permitted to access the restricted activity during occurrence of the conference.

11. The method of claim 9, wherein the deviation allowance specifies a predetermined period of time the computing device is permitted to access the restricted activity during occurrence of the conference.

12. The method of claim 9, further comprising:
receiving a user input requesting access to a restricted activity; and
in response to the user input, controlling access to the restricted activity during occurrence of the conference based on the deviation allowance of the rule.

13. A method comprising:
receiving specification for controlling use of a computing device during a conference associated with the computing device;
generating a rule based on the specification; and
communicating to the computing device the rule for application in controlling use of the computing device during the conference.

14. The method of claim 13, wherein the specification indicates one of an allowable activity and a restricted activity on the computing device.

15. The method of claim 13, wherein receiving the specification comprises:
presenting a user interface configured to receive user input of the specification; and
receiving user input of the specification.

16. The method of claim 13, wherein receiving the specification comprises receiving the specification based on a context of the conference.

17. The method of claim 16, wherein the context of the conference comprises a topic associated with the conference.

18. The method of claim 16, wherein the context of the conference comprises information associated with a participant of the conference.

19. The method of claim 16, wherein the context of the conference comprises information associated with a presenter for the conference.

20. The method of claim 13, wherein receiving the specification comprises:
determining access activity of a user interface associated with a presenter for the conference; and
in response to determining the access activity, receiving input of the specification for controlling use of a computing device during the conference based on the access activity of the user interface.
